(19) United States
(12) Patent Application Publication
(10) Pub. No.: US 2021/0006076 A1
(43) Pub. Date: Jan. 7, 2021

(54) Reconfigurable Energy Storage Module and Optimum Power Transfer Algorithm for Distributed and Modular Energy Storage Systems

(71) Applicant: X-wave Innovations, Inc., Gaithersburg, MD (US)

(72) Inventors: Carlos Rentel, Poolesville, MD (US); Hunter Jones, Silver Spring, MD (US); Karthik Ainala, Laytonsville, MD (US)

(73) Assignee: X-wave Innovations, Inc., Gaithersburg, MD (US)

(21) Appl. No.: 16/900,902

(22) Filed: Jun. 13, 2020

Related U.S. Application Data
(60) Provisional application No. 62/861,383, filed on Jun. 14, 2019.

(51) Int. Cl. H02J 7/00

(52) U.S. Cl. CPC H02J 7/0014; H02J 2207/20; H02J 7/0048; H02J 7/007

(57) ABSTRACT

Systems and methods are disclosed that are related to a set of reconfigurable energy storage modules that can be assisted by an algorithm used to create larger energy storage systems in a flexible and efficient manner. The modules can interconnect in series, parallel or series/parallel and achieve balancing of the energy in every module while providing terminal voltage and/or current control and regulation. The modules can reconfigure on-the-fly and behave as a regular battery, a by-passing unit with a very low resistance, or a module capable of bucking or boosting voltage.

### GOVERNMENT RIGHTS

This invention was made with government support under the terms of Contract No. NNX17CD07C and awarded by the NASA Armstrong Flight Research Center. The government may have certain rights to this invention.

### TECHNICAL FIELD

The present disclosure relates generally to methods and systems for management and control of interconnected energy storage modules, such as battery packs, forming larger energy storage systems. More specifically in the distributed control, management and power regulation of individual interconnected energy storage modules forming larger energy storage systems.

### BACKGROUND

Typically, energy storage modules are used as building blocks to create larger energy storage systems possessing desirable properties. That is, multiple energy storage modules are electrically interconnected in series and/or parallel to create energy storage systems that can satisfy the specific requirements of an application. A possible example of what is meant by an energy storage module is a battery pack, in what follows we sometimes use the word module or battery or battery pack interchangeably, and it is understood that any energy storage module with electrical energy output is applicable, such as capacitors and super capacitors, among others. Battery packs are sometimes interconnected in series and/or parallel combinations to create larger batteries. The reasons for creating larger energy storage systems using smaller modules are numerous and include, but are not limited to, having more energy capacity, producing higher voltages, incrementing redundancy, increasing development flexibility and evolvability, utilizing complimentary energy storage modules to create a higher performance energy storage system, increasing fault tolerance among others.

Modules are then interconnected in series and/or parallel. Modules are sometimes connected directly to one another and other times a method to regulate the individual power out of each interconnected module is necessary. For instance, battery packs directly interconnected in parallel may not share the load in an optimum way due to internal battery pack differences, such as internal impedance differences; on the other hand, battery packs in series may need to regulate their individual voltage to accomplish a given regulated terminal voltage for the entire battery interconnection. The conventional approach to interconnect multiple energy storage modules is to interconnect them directly, perhaps with some protection among the interconnected modules, such as fuses or diodes in between modules or battery packs, and/or to use DC/DC converters between the battery pack and the point where it connects to the load side to be able to control and regulate the energy out of each module. In the latter approach, the DC/DC converter must transfer all the power from its associated battery to the load when the system is serving a load. For instance, if battery packs are connected in parallel, each battery pack may connect to other battery packs through a DC/DC converter of suitable power transfer capability to regulate its associated battery current and make sure all battery packs share the load equally. Conventional approaches are inefficient and potentially unsafe. Interconnecting the modules directly in parallel is inefficient and potentially unsafe as there could be uncontrollable circulating energy among the modules. In the series interconnections some modules could be under-discharged as some others could still hold some energy. This is referred to as imbalance. On the other hand, one major disadvantage of using DC/DC converters between modules and load is the fact that the DC/DC converters need to be designed as large as the maximum power the battery needs to deliver, which adds up to losses in the system. Some conventional approaches to interconnect battery packs using DC/DC converters use DC/DC converters between battery and load, and all the power extracted from the battery must flow through the DC/DC converters.

### SUMMARY

The embodiments can relate to a modular energy management system that can include a reconfigurable energy storage module (“RESM”). In one aspect the RESM can comprise an energy storage module and a processor executing an algorithm to operatively manage the RESM. The processor can execute instructions to perform the step of reconfiguring the RESM for one or more of load power, current, and voltage regulation and control. In another aspect, the energy storage module can include at least two RESMs connected in series, parallel, or series/parallel, where each RESM comprises an energy storage unit and a processor executing an algorithm to operative managing the RESMs and to reconfigure the RESMs for one or more of load power, current, and voltage regulation and control and for balancing the energy storage units.

In other aspects, the algorithm can perform balancing of the energy storage units during charge and during discharge of at least one of the RESMs. In another aspect, the processor can execute the algorithm that performs balancing of the energy storage units simultaneously to the regulation and control of load power, current, and voltage. In still another aspect, the algorithm can minimize losses in the modular energy storage system using the RESMs. In an additional aspect, the algorithm can control simultaneous service of multiple loads with different voltage, current, and/or power requirements in the modular energy storage system. In some aspects, the algorithm can reconfigure the RESM on-the-fly in multiple modes to obtain one of a terminal voltage, current, or power result, regulation and control. In another aspect, the algorithm can control switches inside the energy storage unit for a dual functionality. In one aspect, the algorithm can control bucking of load terminal voltage in the modular energy storage system by using boosted modules and by-passed modules in preference to bucking modules for reasons of efficiency. In another aspect, the algorithm can control a module in bucking mode to transition smoothly monotonically and with small-step transitions between battery and by-passing modes and vice versa to avoid sudden load terminal voltage changes as reconfiguration occurs on-the-fly.

Some embodiments are related to a set of reconfigurable energy storage modules that can be assisted by an algorithm used to create larger energy storage systems in a flexible and efficient manner. The modules can interconnect in series, parallel or series/parallel and achieve balancing of the energy in every module while providing terminal voltage and/or current control and regulation. The modules can reconfigure on-the-fly and behave as a regular battery, a by-passing unit with a very low resistance, or a module capable of bucking or boosting voltage. The capability to reconfigure on-the-fly, the use of multiple modes, and an optimization algorithm, enables higher efficiency operation when boosting or bucking the load voltage. Additionally, the modular architecture can enable higher fault tolerance and operation even when a sub-set of modules discharge first, flexibility of combining multiple types of energy storage systems, flexibility of creating energy storage systems of different sizes with the same standard module, lower ripple noise due to the possibility of staggering the switching waveforms of the different modules' DC/DC converters, and the possibility to supply loads having different requirements, such as different voltage levels. The latter can be useful for example when a high voltage load is powered simultaneously to a low power, auxiliary, load. In such embodiment, a sub-set of the modules can be set to a terminal voltage supplying the low voltage load and all the modules can be set to supply a high voltage load.

One advantage of a modular energy storage system is the possibility to continue operation even when some modules fail, or some modules reach their lower limits earlier. This is particularly important in mission-critical or emergency applications, such as space, aerospace, medical, and military applications, but also in commercial applications where lives are at a stake, such as in hybrid or electrical vehicles. The user of such an exemplary energy storage system would want to reach a safe state or safe destination or port prior to the entire system failing, which can render the system on which it depends on useless, in some other cases not being able to isolate the faulty sections of the energy storage system can be dangerous. For this and the other reasons herein and known to one skilled in the art, modular approaches are particularly attractive in those scenarios and applications. The embodiments can isolate faulty units and leave other non-faulty ones operating or turned down smoothly introducing greater control, greater safety, and greater fault tolerance capabilities.

Other features and advantages of these embodiments will become apparent from the following detailed description of the presently preferred embodiments taken in conjunction with the accompanying drawings.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a schematic of a typical advanced battery pack system that uses Lithium-ion cells, a bi-directional switch to on/off control the energy in or out of the battery pack, and a battery management system (bms).

FIG. 2 is an illustration of embodiments showing different modes in a Reconfigurable Energy Storage Module (“RESM”).

FIG. 3 is an embodiment of an RESM using switches to reconfigure the RESM into its different modes as shown previously in FIG. 2, and to disconnect the RESM from a load or other modules when all switches are in an off position.

FIG. 4 is an embodiment of an RESM using switches to reconfigure the RESM into its different modes and so that when all switches are in an off position the RESM presents diodes' cathodes on its positive terminal and diodes' anodes on its negative terminals.

FIG. 5 is an illustration of multiple RESMs interconnected in series forming a larger energy storage system of the embodiments.

FIG. 6 is an illustration of multiple RESMs interconnected in parallel forming a larger energy storage system of the embodiments.

FIG. 7 is an illustration of multiple RESMs interconnected in series forming a larger energy storage system of the embodiments where several regulated terminal voltages are generated simultaneously.

FIG. 8 is a bare battery to/from boost mode transitions using a laboratory prototype of the embodiments.

FIG. 9 is a bare battery to/from buck mode transitions using a laboratory prototype of the embodiments.

FIG. 10 illustrates several transistor-based switches of the embodiments that can be implemented in a RESM.

FIG. 11a is a flowchart of a master-less implementation of the embodiments.

FIG. 11b. is a flowchart of a master-slave implementation of the embodiments.

FIG. 12 is a time graph of an exemplary balanced discharged.

FIG. 13 is a graph of exemplary multiple balanced discharges with SOC versus normalized time of the embodiments.

FIG. 14 is a graph of exemplary SOC dynamics at two different converter transfer ratios that achieve balancing showing a fast balancing embodiment that results in a maximum terminal voltage and a slow balancing embodiment that results in a minimum terminal voltage.

FIG. 15 is an example graph of exemplary SOC dynamics showing the boundaries for other candidate solutions part of an algorithm of the embodiments, where other points within the region may be feasible solutions. Three regions are shown that overlap and are illustrated in the next figures separately.

FIG. 16 is an example graph of Region N=3 of FIG. 15, where no RESM is bypassed (forced into limping mode) therefore all RESMs are allowed to discharge to a point within region 3 not including the top horizontal line.

FIG. 17 is an example graph of Region 1 of FIG. 15, where all RESMs are bypassed except the one with largest SOC and this example SOC₂[k]=SOC₃[k]=1, and only the RESM with largest SOC is allowed to discharge to a point within region 1.

FIG. 18 is an example graph of Region N−1=2 of FIG. 15, where RESM N is bypassed and the rest are active, SOC₃[k]=1, and all the other RESMs are allowed to discharge to a point in region 2 not including the top horizontal line.

FIG. 19 is an example graph of exemplary SOC dynamics showing a different point within the allowed regions where a particular point achieves balancing before the batteries are empty.

FIG. 20 is a flowchart of high level strategy of an exemplary RESMs algorithm for balancing and terminal voltage regulation of the embodiments.

FIG. 21 is a flowchart of an exemplary optimization algorithm performed prior to a time block for the next time block of the embodiments.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

It will be readily understood that the components of the present embodiments, as generally described and illustrated in the Figured herein, may be arranged and designed in a wide variety of different configurations. Thus, the following more detailed description of the embodiments of the apparatus, system and/or method, as presented in the Figures, is not intended to limit the scope of the embodiments, as claimed, but merely representative of selected embodiments.

Reference throughout this specification to “a select embodiment,” “one embodiments,” “some embodiments,” or “an embodiment” means that a particular feature, structure, or characteristic described in connection with the embodiment is included in at least one embodiment. Thus, appearances of the phrases “a select embodiment,” “one embodiments,” “some embodiments,” or “an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the embodiments can be practiced without one or more of the specific details, or with other methods, components, materials, etc. In other instances, well known structures, materials, or operations are not shown or described in detail to avoid obscuring aspects of the embodiment.

The embodiments address a need to regulate the power of individual exemplary energy storage modules as part of a larger energy storage system. Reasons for requiring power regulation for each module in an interconnected energy storage system can vary. For example, battery packs in parallel tend to have circulating currents among them that make their parallel interconnection inefficient if some form of power control or regulation is lacking. This is due to the presence of circulating currents and unequal load sharing among the paralleled battery packs. Battery packs in series may also require individual power control as they can become imbalance if their energy is extracted disregarding their specific and individual state of charge (i.e., “SOC”). Another reason for individual power regulation is the possibility to maintain a fix regulated terminal voltage or a fix terminal current for the entire energy storage system by utilizing distributed and modular DC/DC conversion in every module as opposed to using a single larger DC/DC converter between the interconnected modules and the load. These, and other energy storage modular and distributed applications, may require proper control of the energy extracted out of each energy storage module that is part of a larger energy storage system, or energy into each energy storage module for the purpose of charging it. The embodiments can provide devices and methods to perform on-the-fly, or while current is being delivered to a load while discharging the batteries or delivered to the batteries while charging, re-configuration, power control/regulation of each individual energy storage module part of a larger energy storage system.

Thus, the methods and systems of the embodiments can be executed or implemented, respectively, either or both while delivering power to a load (that is discharging) and/or while charging batteries in an energy storage system.

The resulting embodiments for an energy storage system can use a distributed and efficient DC/DC power conversion approach, which can be combined with a number of additional electronic components and associated algorithm that are used to minimize, for instance, the losses through the distributed DC/DC converters by way of minimizing the amount of power transferred through the DC/DC converters. The approach can be used to by-pass energy storage modules if needed, and regulate the power, voltage and/or current of each individual module to accomplish a specific objective. For example, the approach can be used to maintain a boosted, bucked, or regulated terminal voltage in the entire interconnected energy storage system in a distributed manner while simultaneously extracting the energy of each individual energy storage module in proportion to the energy storage module, say, state of charge (SOC) and/or state of health (SOH). This approach can function regardless of the type, chemistry, manufacturing origin, size, or age of each individual and interconnected energy storage module, or whether the modules are connected in series, parallel or a combination thereof. The embodiments can also be used for energy balancing in series interconnections, for controllable load sharing in parallel interconnections, to provide regulated terminal voltage and/or current to a load in a distributed manner, and/or to balance the energy of the energy storage system and regulate the power while charging.

Some embodiments can relate to a reconfigurable energy storage module and its optimum used when interconnected to similar modules forming a larger energy storage system. The outcome of the use of the reconfigurable module combined with a distributed algorithm that optimizes the configuration and transfer of energy from the storage modules to the load is an overall energy storage system that can be power, voltage, and/or current controlled with higher efficiency than the conventional approaches previously mentioned. Higher efficiency can be achieved by avoiding transferring all power through the DC/DC converters as in conventional approaches, and can be achieved by using re-configurability according to the embodiments. The method and apparatus of these embodiments can be equally useful when modules are interconnected in parallel or in series, and for different or similar energy storage modules, where the difference may mean chemistry, type, age, manufacturing origin, size, among others. The higher efficiency of the embodiments can enable users to create energy storage systems that are modular and distributed, but also with less losses than existing methods, which in turn makes modularity and distributed energy storage systems more efficient and attractive.

In many cases, exemplary interconnected energy storage modules can be of the similar or same type and, possibly, of the similar or same manufacturing origin, for example battery packs from the same manufacturer having cells of the same chemistry. In other embodiments, it can be desirable to interconnect energy storage modules of dissimilar properties or even manufacturing origins. The former creates what is referred to as a homogeneous energy storage system, and the latter a heterogeneous energy storage system. An example of a heterogeneous energy storage system is the interconnection of battery modules having high capacity capability with energy storage modules having the capability to deliver their energy quickly (i.e., having high power capability), such as certain battery chemistries and capacitors. The combination of dissimilar modules in this manner can result in energy storage systems that can, for instance, last longer and are more efficient at delivering the stored energy in applications having large peak to average load demand ratios.

Some embodiments interconnect re-configurable energy storage modules to create larger energy storage systems. A reconfigurable module can operate in different modes that may be setup prior to powering the load or on-the-fly, in other words while delivering power to the load. The on-the-fly (while current is being delivered to a load) mode reconfiguration capability can be combined with a distributed algorithm that can optimizes the transfer of energy from the interconnected modules to a load resulting in a more efficient system. The different modes the exemplary reconfigurable module can be set to can include: a by-passing mode, a battery mode, a (voltage) boosting mode, and a (voltage) bucking mode. The by-passing mode can disconnect the battery pack in a module and can provide a path for the current to flow in parallel to the disconnected battery pack (i.e., by-passing). In the battery mode, the module can configure the battery pack on its terminals, in boosting mode the module can provide a voltage boost with respect to its battery pack. In the bucking mode, the module can provide a lower voltage with respect to its battery pack. The distributed algorithm can compute periodically and in a distributed manner the appropriate mode and the amount of power transfer through each DC/DC converter in every reconfigurable energy storage module. In an embodiment, when the reconfigurable module is in the battery mode or the by-passing mode, no DC/DC converter is used, which can effectively translate in zero losses through the DC/DC converter.

In an exemplary application of the embodiments, several Reconfigurable Energy Storage Modules, referred to hereafter as “RESM”, can be interconnected in series, and the application can require a regulated terminal voltage at the terminals of the overall energy storage system. This is a typical scenario, for instance, in some electric vehicles, where a string of series batteries are conventionally connected to a DC/DC converter that boosts the voltage and maintains the voltage regulated to provide power to a high voltage electric motor or an inverter prior to the motor. In some embodiments, a distributed algorithm can command each individual RESM to transition to a mode: by-passing, battery, boosting, or bucking depending on the required terminal voltage of the overall interconnected energy storage system, and in conjunction with a optimization objective. This optimization may be the minimization of the total power transferred through DC/DC converters in the RESMs, among others. Besides selecting the appropriate mode for each RESM, the distributed algorithm can decide the set-point of the DC/DC converters in all RESM configured either in bucking or boosting modes if it is desired to comply with the required terminal voltage. The distributed algorithm may also attempt to use the interconnected RESMs in proportion to their state of charge (SOC). That is, if a RESM has larger SOC than another, the latter can be discharged slower than the former to eventually balance the use of each RESM and extract more energy out of the overall energy storage system formed by the series interconnection of RESMs. One advantage of using the RESM in combination with the optimization algorithm is that the overall energy storage system is more efficient at simultaneously balancing the energy extracted out of the storage modules and providing a total regulated terminal voltage. The embodiments have advantages in situations where regulated power, voltage or current is needed out of an energy storage system formed by multiple interconnected smaller energy storage modules. Furthermore, because of added efficiency, balancing an entire energy storage system while delivering the energy of each module to the load in a regulated manner becomes advantageous. This can be because the losses through DC/DC converters in the RESMs are minimized through the appropriate mode utilization in on-the-fly reconfiguration. Further, having multiple RESMs can enable a possibility of switching the multiple DC/DC converters staggered in phase from one another, which can reduce ripples in the load.

The following description of some embodiments is divided in two sub-sections. In the first sub-section, the RESM module, which is the core building block used in a larger energy storage system, is described. The second sub-section describes the optimization algorithm used to simultaneously extract energy of each RESM module in a balanced manner while maintaining control or regulation of either voltage, current or power and as part of the entire energy storage system (i.e., an energy storage system formed by interconnected RESM modules). Some embodiments can use hardware components that are based on mature and conventional technologies, such as silicon MOSFETs, no new materials are necessarily needed, but could be used, such as the use of wide band gap transistors: GaN or SiC transistors.

### Reconfigurable Energy Storage Modules

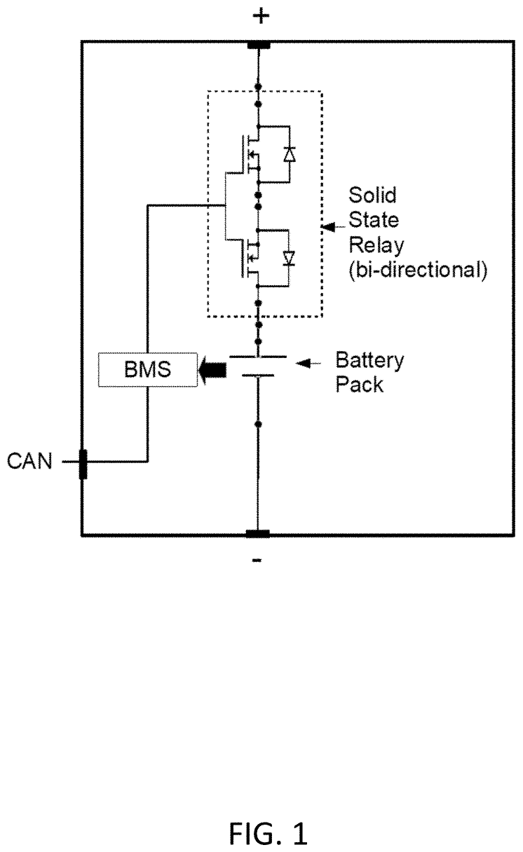

FIG. 1 is a schematic of a typical advanced battery pack module that uses Lithium-ion cells. These packs typically have a Battery Management System (BMS) and communication interfaces, such as Control Area Network, additionally they also have a mechanism to switch it on/off or interrupt current as in a circuit breaker, and most commonly it is implemented as a solid state relay or breaker composed of back to back transistors as shown. The solid state relay can be re-used by the RESM to accomplish its on-the-fly mode, changing, or reconfiguration functionality as will be shown soon. This means the existing solid state relay can be re-used as part of the RESM implementation which reduces the number of added components.

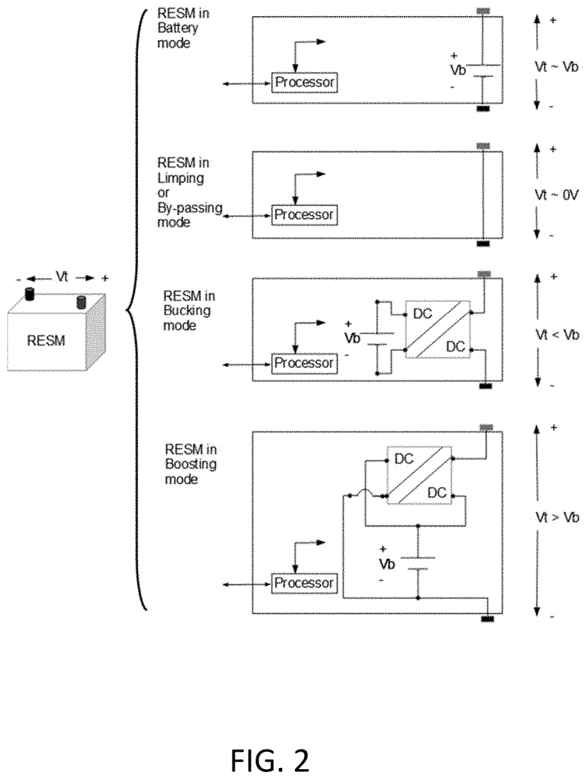

FIG. 2 is an illustration of embodiments showing different modes in a Reconfigurable Energy Storage Modules (“RESM”). In other words, FIG. 2 shows a simplified illustration of four different modes the RESM can be reconfigured by a processor, or Battery Management System (BMS), that can be operatively connected to the RESM and can manage and/or control the operation of the RESM, and also communicate to other RESM processors and/or external controllers. These modes can be transitioned to on-the-fly, or while current is being delivered to a load while the RESM is delivering power, or when current is being delivered to the batteries from a charger or chargers, while interconnected to other energy storage modules, such as other RESMs or others. The architecture of the RESM allows it to change modes without interrupting current flow and with monotonic transitions of voltage as will be shown in what follows. FIG. 2 is a simplified illustration of the modes in which a RESM can be reconfigured in the embodiments. Additional details of the components that can be implemented to accomplish these modes are described below in exemplary embodiments. Note that a processor is represented with two bi-directional arrows. An internal bi-directional arrow can indicate control, management, and/or control/monitoring of the RESM internal functions and algorithms, including switching actions and, say, estimation of SOC of the battery in the RESM. The bi-directional arrow straddling outside the outer box logically representing the RESM, can indicate a communication interface with external processors, circuits, hardware, software, etc.

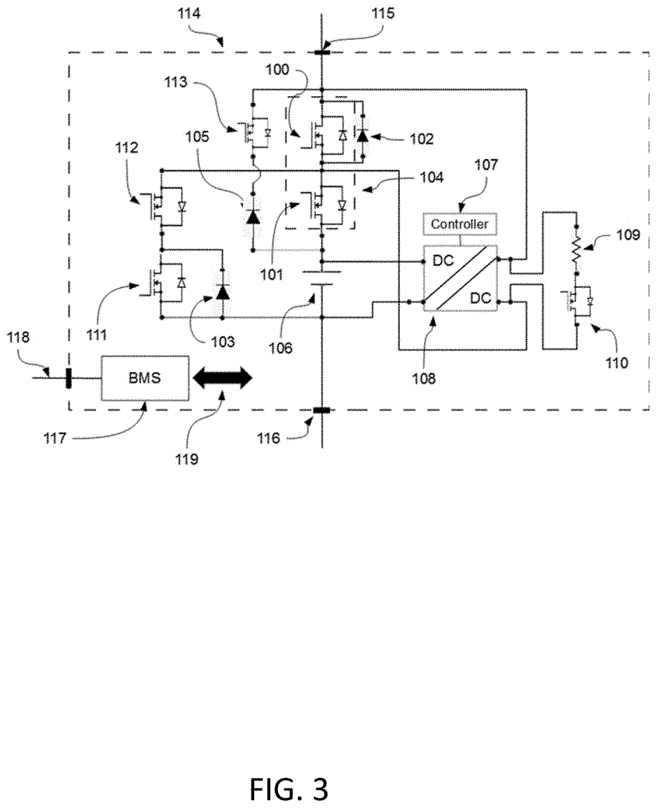

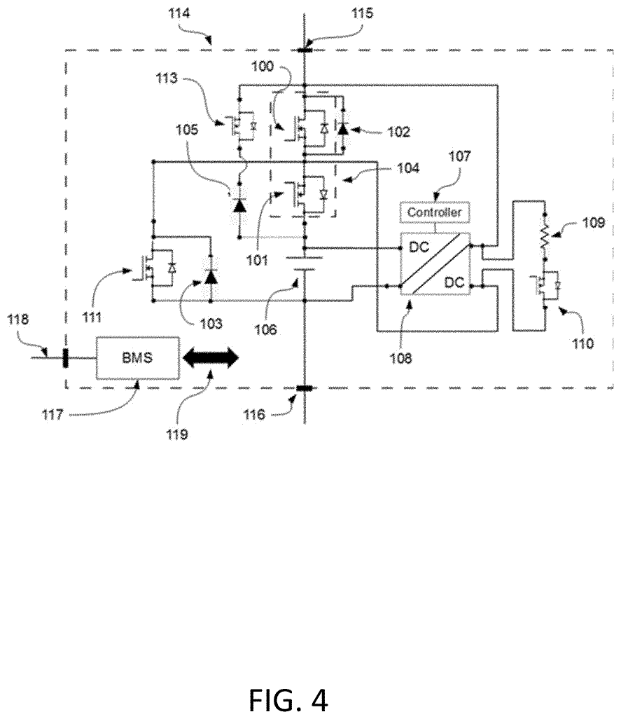

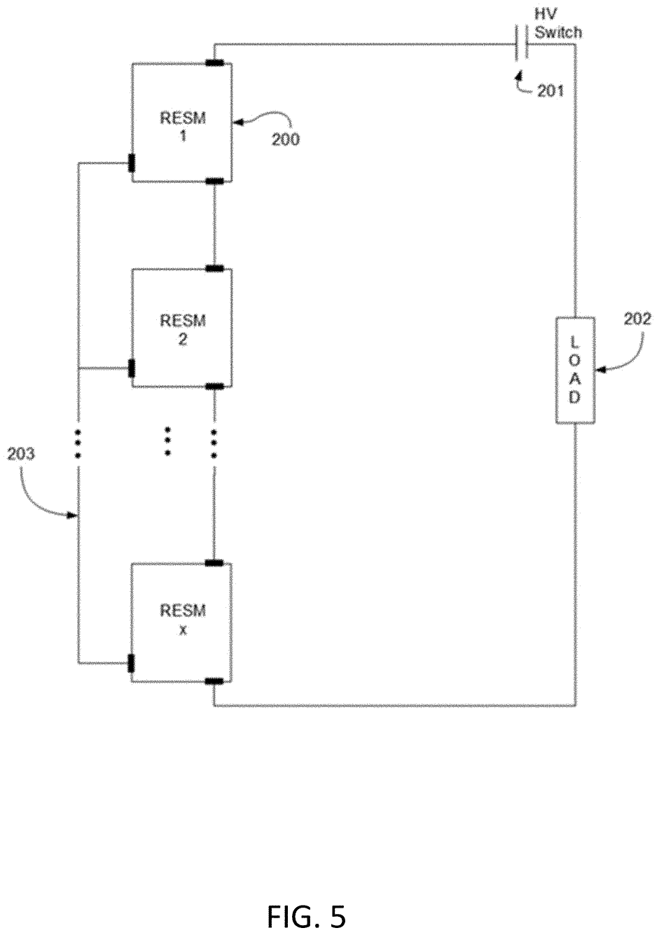

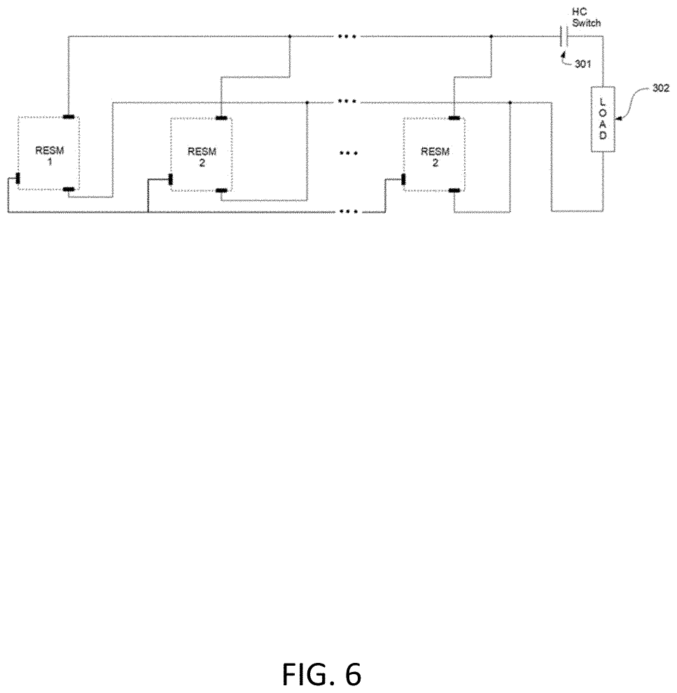

FIG. 3 is an embodiment of an RESM using switches to reconfigure to any of the different modes disclosed and to disconnect the RESM from a load or other modules when all switches are in an off position. The RESM is the building block of a larger energy storage system. RESMs may be interconnected in series as shown FIG. 5, parallel as shown in FIG. 6, or series/parallel.

Referring to FIG. 3, the RESM 114 presents three interface connections, 115, 116, and 118. The power interface connections are 115 and 116, whereas 118 is a communication interface. The positive power terminal connection is shown at 115, and the negative power terminal connection is shown at 116. The interface 118 may be wired or wireless and can be used to communicate to other RESMs and possibly to another remote processing module or controller/monitoring device. The RESM has a Battery Management System (BMS) 117, or some computational or processing node of similar functionality, which can monitor some or all battery pack parameters but can also control some or all switches represented as N-MOSFETs in the diagram. The BMS can use interface 119 to accomplish its monitoring and control tasks. The BMS can obtain power from the battery pack itself. Interface 119 is generically represented as a thick black bi-directional arrow to simplify the description, but it can be one or multiple physical interfaces. Controller 107 can be responsible for driving the DC/DC converter. Controller 107 can be the controller that can implement the close loop control of the output of the DC/DC converter and generates the signals that drive the internal switches of the DC/DC converter. The DC/DC converter 108 can be one or multiple DC/DC converters connected in series and/or parallel and of different types, uni-directional or bi-directional and current or voltage fed of multiple variants. A setting for controller 107 can be determined by an algorithm operating in or for the BMS. For instance, output voltage of the DC/DC converter and/or output current. In an embodiment, the RESM can transition between different modes on-the-fly while current is flowing or off when current is not flowing. In one embodiment, there are the following four different modes: by-passing or limping mode, battery mode, boosting mode, and bucking mode as described previously. A transition to different modes may be performed on-the-fly, meaning, for instance, while current is being delivered to a load, therefore current cannot be interrupted and voltage transitions should follow a monotonic function of time. The two latter conditions can be implemented for noise reduction, and for the low-cost and practical implementation of the RESM by using low voltage components.

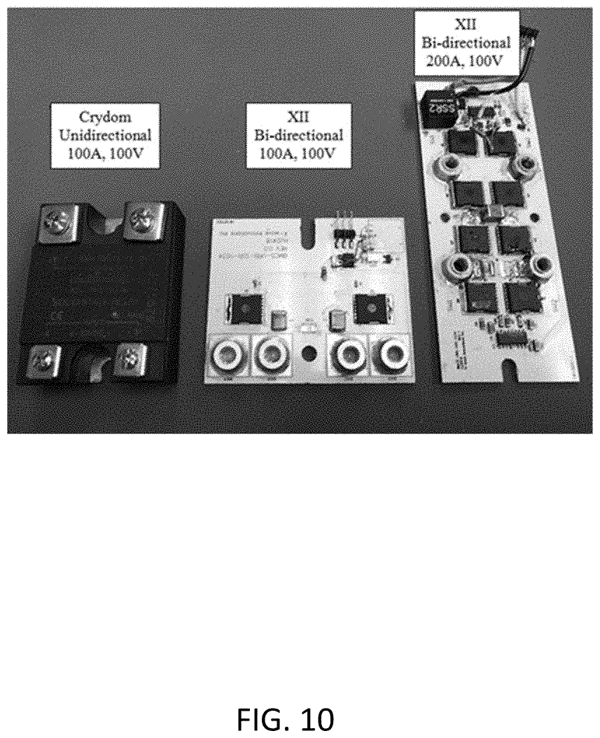

Transistors 100 and 101 can be installed external to the battery pack or can be existing transistors internally integrated into a battery pack, and typically used to connect/disconnect the pack and/or for protection as in a circuit breaker designed with transistors as shown in FIG. 1. An embodiment of the RESM can be completely disconnected from any system by opening all transistors shown in FIG. 3. The RESM can be set into bare battery mode when all transistors are off except transistors 100 and 101. Turning on transistors 100 and 101 then can connect the battery pack to the RESM terminals 115 and 116. Note that some lithium-ion battery packs may already include a BMS and have solid state circuit breakers or switches, such as 100 and 101. The components added to such a battery pack in order to transform it into a RESM can comprise a controller 107, DC/DC converter 108, with its minimum load 109, transistors 111, 112, 113, and diodes 102, 103, and 105. Transistors 111 and 112 can advantageously handle as much current as transistors 100 and 101, which is the reason they may have the same sizes. Transistors 113, 110 may have smaller sizes to indicate they are active for only a very brief time, such as in the order of micro-seconds or less, while the module is transitioning between modes, and most of the time they are off, which can indicate transistor 113 and 110 potentially do not require much heat sinking and can be single discrete parts; this is the same for diodes 102, 103 and 105. The other transistors may need to transfer larger current for longer periods of time therefore they may be one larger transistor or several transistors in parallel. An example of several exemplary implementations of transistors 112 and 113 is shown in FIG. 10. For example, there is a commercial unit by Crydom capable of 100A unidirectional switching, and two units designed and fabricated according to the embodiments that can be capable of bi-directional switching. The unit on the extreme right is capable of 200A and 100V and measures only 1.75″ wide×4.5″ long×0.25″ tall. These can be fabricated with aluminum substrate, but due to their low loss they can be made smaller if using additional layers and FR4 substrate.

FIG. 3 is an embodiment of an RESM using switches to disconnect the RESM from a load or other modules when all switches are in an off position. Referring to FIG. 3, the RESM can transition from different modes on-the-fly while it is delivering power to the load. The explanation of each mode transition is ended with an oscilloscope capture of the transition in a prototype in our lab.

### Battery Mode to Boosting Mode

In FIG. 1, transistors 100 and 101 are on and all the rest are off initially. This implies the RESM is in Battery mode delivering power to a load as a battery in series with transistor(s) 100 and 101. Transistors 100 and 101 may be a single transistor or several transistors in parallel.

Transistor 100 can be opened. This configures current flow through body diode of 100 and diode 102 in parallel, where the RESM is still in Battery mode with a voltage in its terminals equal to the battery voltage minus a diode voltage drop and the drop in transistor 101, which is negligible due to its small resistance in the on position. The secondary of 108 is at a negative voltage equal to a diode voltage drop of 102. This is insufficient to make current flow into 108 secondary rectifier.

Transistor 110 may be turned on to ensure the DC/DC converter always has a minimum load. In a non-limiting example, the DC/DC converter 108 is turned on. As output voltage of DC/DC converter 108 is ramped up, DC/DC converter 108 applies a reverse voltage on body diode and diode 102. When the voltage is positive on the output of 108, the body diode of 100 and diode 102 open. This can configure the battery pack in series with the output of DC/DC converter 108, which can deliver power through the power terminals 115 and 116. At this point DC/DC converter 108 can be set to the desired voltage starting from the battery pack voltage, and the boosted voltage of the RESM 114 is the series of the battery pack and the output voltage of the DC/DC converter 108.

### Boosting Mode to Battery Mode

Referring to FIG. 1, when transistor 100 is in an off configuration, the embodiment can enable the RESM to transition from behaving as a battery to behaving as a battery with a boost converter, except that not all the power delivered transfers through the DC/DC converter 108. A fraction of the power can transfer through the battery and the other fraction through the DC/DC converter 108. Additionally, a transition from battery pack to boost mode can be smooth without interruption of current flow. The latter implies the transition can be made on-the-fly as the RESM is delivering power, which is important for the overall performance of the interconnected energy storage system. To transition back to battery mode from boosting mode the DC/DC converter 108 can be configured to an off mode. This can remove the reverse voltage on body diode of 100 and diode 102 and the current can flow from the battery through 101 and body diodes of 100 and diode 102. Transistor 100 can then be configured to an on state and the RESM 114 can be placed back into battery mode without current being interrupted.

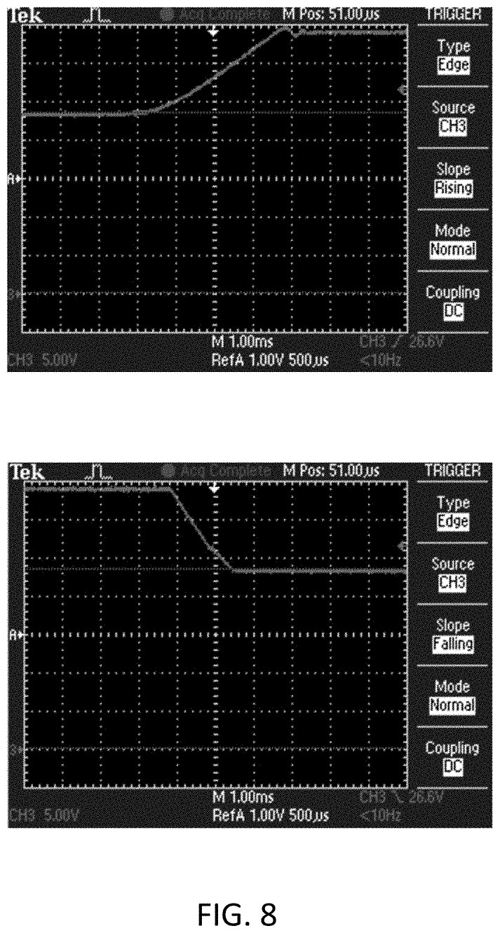

FIG. 8 illustrates a battery to/from boost mode transitions using an implementation of the embodiments. This shows monotonic voltage changes on the load and no current interruption on the resistive load.

### Battery Mode to Bucking Mode

In some embodiments, transistors 100 and 101 are on and all the rest are off thus the RESM is in battery mode. When transistor 100 is opened, this can cause current flow through body diode of 100 and diode 102; thus the RESM is still in battery mode with a voltage in its terminals equal to the battery voltage minus a diode voltage drop. The secondary of DC/DC converter 108 can be at a negative voltage equal to a diode voltage drop of 102. This is insufficient to make current flow into 108 secondary rectifier, which can be opened or off. When transistor 113 is closed, this does not change the voltage in the terminals 115 and 116 of the RESM. Transistor 110 may be configured to an on mode to ensure the DC/DC converter 108 always has a minimum load during mode transitions.

When transistor 101 is configured to an open mode, this also does not change the voltage of the RESM at terminals 115 and 116 thanks to the conduction of diode 105 through transistor 113, but this embodiment can cause a brief drop of the voltage of the RESM equal to the battery voltage minus a diode drop on the output of the DC/DC converter 108 (for example, typically less than 0.7V in one embodiment); at this point the secondary of the DC/DC converter 108 will not allow any current to flow inside it as it will be configured in an off state.

When transistors 111 and 112 are closed, the embodiment can connect the negative of the output of the DC/DC converter to the negative of the battery, but still the RESM is at battery voltage minus a diode drop. DC/DC converter 108 can be turned on and set to a voltage close to the battery voltage by BMS 117 and controller 107. BMS 117 can set the desired target voltage, and controller 107 can implement the closed loop control to maintain that desired target voltage, the controller is set to battery voltage. While the DC/DC converter is ramping up to battery voltage, the DC/DC converter can perform this task quickly on its minimum load while the battery delivers all the power to the main load via diode 105 and transistor 113. When the DC/DC converter reaches close to battery voltage, a reverse voltage on diode 105 can then be applied, which opens it, at which point the DC/DC converter takes over the load at a voltage close to the battery voltage. Next transistor 113 can be opened and set to a desired output voltage of the DC/DC converter to a desired voltage which is lower than battery voltage, which in turn sets the REMS terminal voltage to a voltage lower than the battery voltage in buck mode. The latter ensures a monotonic voltage change from battery mode to buck mode without interruption of current throughout the procedure.

The transition from battery to bucking mode can also be performed without current interruption. The voltage may experience some variation at times when DC/DC converter 108 takes on the full load, and that can be adjusted by design of the speed of controller 107. One skilled in the art will understand that since the RESM is bucking anyways, this dip is mostly inconsequential.

### Bucking Mode to Battery Mode

To transition back to battery mode the DC/DC converter 108 can be ramped up to a voltage close to the battery voltage. Next, transistor 113 can be closed. Diode 105 will not conduct as its forward voltage is low. After these steps, can DC/DC converter 108 can be placed in an off configuration. The latter puts the battery voltage minus diode drop on the terminals 115 and 116 of the RESM since diode 105 will now conduct after DC/DC converter 108 is turned off. At this stage, transistors 101 and 102 can close and transistor 113 can open, placing the RESM in battery mode without current interruption and a monotonic voltage transition.

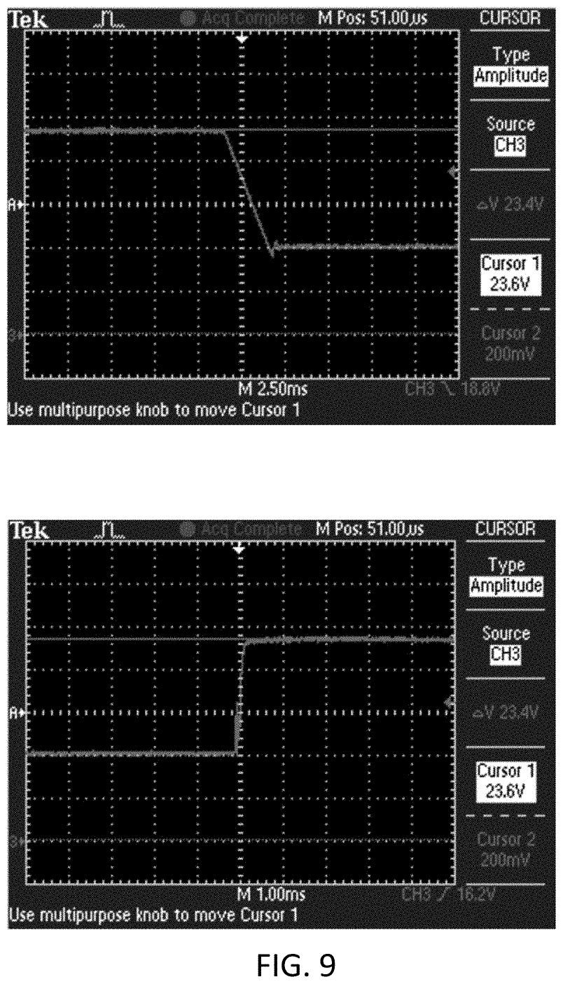

FIG. 9 illustrates a battery to/from buck mode transitions using an implementations of the embodiments. These show monotonic voltage changes on the resistive load and no current was interrupted in the transition. Transitions from/to by-passed to/from bucking or boosting modes are also possible, but not shown for brevity. In a system using RESMs delivering full power, the bucking mode is never used continuously in the embodiments. This is because the DC/DC converters 108 used in a RESMs can be designed to transfer less power than what a single RESM can deliver. Furthermore, in FIG. 2 the exemplary DC/DC converter can be used in boosting mode and bucking mode. In boosting mode, a fraction of the power delivered by the battery or energy storage unit is transferred to the load via the DC/DC converter, this means the DC/DC converter does not need to be designed with the maximum power capability of a RESM. On the other hand, in the bucking mode all power can be delivered by the battery, or energy storage unit, and can be transferred through the DC/DC converter. In that case the DC/DC converter can be designed so that it transfers all power coming out of the battery (or energy storage unit, whatever that may be). In order to use embodiments that can comprise lower power DC/DC converters, the embodiments can comprise designs to satisfy the power transfer of the boosting mode. In such an embodiment, the bucking mode cannot be used continuously to buck to certain voltages and under loads that demand higher powers than what the DC/DC converter can transfer. Bucking voltages at loads that demand higher power than what a DC/DC converter can transfer can be accomplished, however, using two more efficient modes: boosting mode combined with battery and by-passing modes. The bucking mode, however, is useful as it allows the RESMs to transition from battery mode to by-passing mode and vice versa smoothly and in a controlled manner. That is, when two RESMs must switch modes, one can transition from battery mode to by-passing mode and another from by-passing mode to battery mode, rather than performing the steps in a single step. Even if the steps are accomplished almost at the same time, such a large step can cause a possibly undesired terminal load variation. Instead, bucking can be performed in opposite directions for a brief moment. That is, the RESM in battery mode can be bucked down to close to by-passing mode and the RESM in by-passing mode can be bucked up to battery mode. Bucking mode can move smoothly in small but fast steps and avoid large changes in terminal voltage load. As shown, from bucking to battery mode or from bucking to limping mode the transition is monotonic and without current interruption, or so called smooth. A DC/DC converter designed to continuously transfer less power can then be used briefly in this manner to transition smoothly between modes as long as it is done sufficiently fast.

In a conventional system to accomplish a similar task, assume the power each module needs to deliver is maxLoadPower/N, where N is the number of modules in series, this means the DC/DC converter must also transfer maxLoadPower/N. In the embodiments, however, if only the boosting mode uses the DC/DC converters continuously the DC/DC converter must transfer an estimated maxLoadPower/2N assuming the output of the DC/DC converter is never larger than the voltage of the battery, or energy storage unit. This is because half of the power from the battery can be transferred through the DC/DC converter and half can be delivered directly by the battery. One skilled in the art can recognize other embodiments could be greater or less than half of the power in each circumstance and not depart from the scope of the embodiments. If the exemplary RESMs are configured to deliver maxLoadPower/N but configured into bucking mode, the DC/DC converter power will be exceeded if the RESMs are designed to transfer maxLoadPower/2N nominally. Such configurations may not affect functionality, however, if performed for a brief moment in the sub-second order, and can be used for a transition, but not continuously. The former (use it in a transition) can be used to transition from battery mode to by-passing mode and vice versa as disclosed above, and use a combination of boosting with battery and by-passing mode to obtain a bucked voltage instead. That is, for example if three RESMs are in series, each with a battery of 24V and a voltage of 56V is needed at the load terminals it is preferred to have one RESM in by-passing mode and two RESMs in boosting mode for example, or one RESM in battery mode and one in boosting mode and one in by-passing mode than any in bucking mode. However, having a RESM in by-passing mode can imply imbalance will be inevitable eventually, which requires the system to change the RESM that is being by-passed. In that case, when moving to/from by-passing or to/from battery mode bucking mode can be used briefly to avoid drastic changes in load terminal voltage and take a RESM in battery mode to by-passing mode, or a RESM from by-passing mode to battery mode.

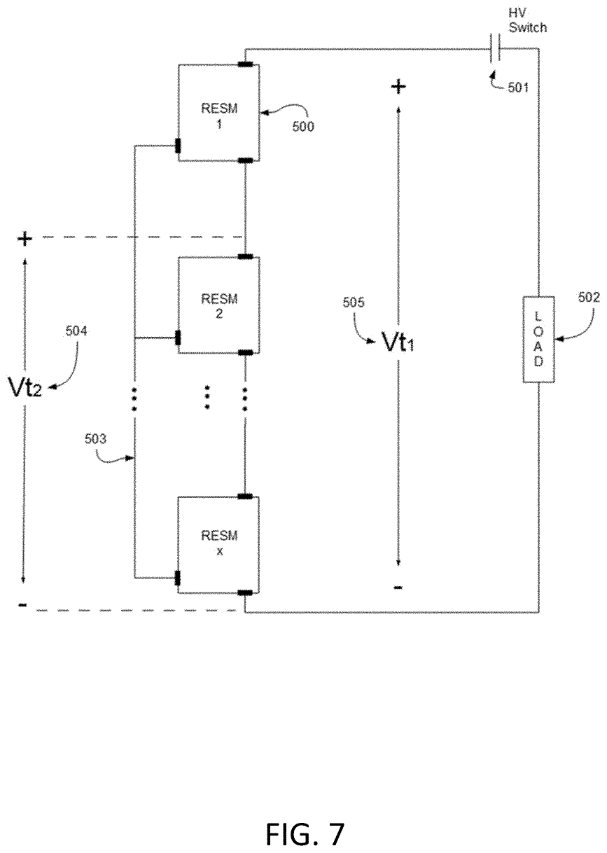

The modularity of the embodiments allows for a system such as the one in FIG. 7, where multiple regulated/controlled terminal voltages can be provided by the same energy storage system. The entire interconnection of RESMs can provide a controlled main load terminal voltage simultaneous to a low voltage regulated terminal voltage provided by a sub-set of the RESMs. This may be possible depending on load characteristics. This is useful for auxiliary loads. An isolated DC/DC converter can be used to separate the ground of both systems, and still provide benefits as the input voltage may be maintained closer to the output voltage which makes the DC/DC converter run more efficiently. FIG. 10 shows several variations of the solid state relays uni-directional and bi-directional of the embodiments.

### Optimization Algorithm for Interconnected RESMs

The sub-division of a single monolithic battery connected with a single monolithic DC/DC converter into several smaller battery modules each with its own smaller DC/DC converter can be attractive for logistical reasons and reasons of fault tolerance among others as described previously, but also it can be more efficient in some important cases. The increased efficiency is possible thanks to the possibility to reconfigure the RESMSs on the fly, and more advantageously when the boosting mode, by-passing mode and battery mode are selected over the buck mode. The buck mode, however, is critical for a smooth transition between some of the modes, and it can be used briefly as the RESM transitions from battery mode to by-passing mode or vice versa to avoid large changes in the load terminal voltage as also explained previously.

In some embodiments, an exemplary optimization algorithm may be used for an appropriate selection of the mode each module can operate within and to select each module's setting. The exemplary optimization algorithm may be implemented in a master-slave approach or a master-less approach, and it can preferably compute the modes and settings based on information available from the RESMs. The RESMs may be interconnected in series, parallel, and/or series parallel combinations for the purpose of creating a larger energy storage system that has adequate capacity, suitable terminal voltage, power, or current capability. An embodiment for an exemplary algorithm for a series interconnection of RESMs can be provided and implemented, but it is understood that other interconnections are possible and may benefit from the optimization performed by the algorithm.

When interconnecting energy storage modules, such as RESMs, it can be desirable to regulate and control one or more electrical variables of the overall energy storage system formed by the interconnection of individual modules. For example, if the embodiments for energy storage modules are configured in series, then the embodiments may regulate and control the terminal voltage of the overall energy storage system. If the embodiments for energy storage modules are interconnected in parallel, then it can be advantageous to regulate both the overall current and voltage. Additionally, it may be desirable to extract the maximum energy out of each energy storage module efficiently. That is, regardless of module differences in, for example, state of charge (SOC), state of health (SOH) or differences in chemistry, type, size, or manufacturing differences among modules, it may be desirable to extract as much of the energy out of each module as possible to maximize the energy storage system range or single-cycle discharge duration.

The exemplary algorithm of the embodiments can minimize the amount of energy transferred through the DC/DC converters in every RESM's constraint to maintaining a regulated and controlled desired terminal voltage and/or current while simultaneously extracting the energy of one or more RESMs in a balanced manner. The latter implies all RESM storage modules will eventually discharge to a point where all their SOCs are similar. In other embodiments, a series interconnection of RESMs can maintain a desired fixed terminal voltage while balancing the SOC of the RESMs, where each RESM can be implemented using battery packs, a number of switches and other components.

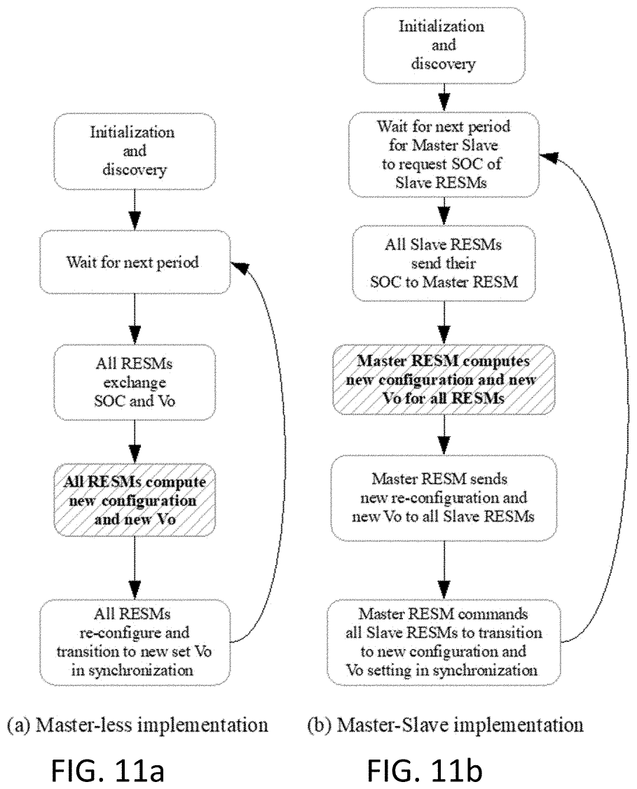

In other embodiments, an exemplary distributed algorithm may be implemented as a master-less approach or as a master-slave embodiments as shown in FIG. 11a and FIG. 11b, respectively. The computation of the new configuration and set-point, shown as a hatched rectangle in FIG. 11a and FIG. 11b, represent a core of the algorithm. Vₒ in the figures is the output voltage of each RESM. Execution of the exemplary distributed algorithm can cause the sum of all Vₒ voltages in all RESMs to equal the desired target terminal voltage Vₜ of the energy storage system composed of, say, N series interconnected RESMs plus or minus some allowed tolerance ΔVₜ. That is Vₜ−ΔVₜ≤Σᵢ₌₁^{N} V_{o,i}≤Vₜ+ΔVₜ where i is the index representing the i^{th} RESM.

Furthermore, the exemplary distributed algorithm can attempt to simultaneously balance all SOCs in all RESMs as the energy is delivered to the load. That is, in some embodiments it may be unacceptable to have some RESMs discharged more than others, eventually at some point in time, before the first RESM is empty (whichever that may be), and all RESMs must have a similar SOC. This is necessary when it is desirable to ensure extraction of the maximum amount of energy from all RESMs, which can help maximize the life of the overall energy storage system and the amount of energy extracted in a single discharge.

### Computation of New Configuration and Output Voltages by Optimization Algorithm

Other embodiments can include an exemplary optimization algorithm that can compute new configurations and determine output voltages of the RESMs. The exemplary optimization algorithm can execute instructions in a processor, or similar hardware, and a memory in the RESM, or an external processor and memory that can control actions of the RESM. The RESM where the exemplary optimization algorithm can be implemented can be either a so-called master RESM in a master-slave approach or every RESM computes when a master-less approach is used; both configurations can be configured. The computation may require the SOC of all RESMs and the battery voltages in each RESM. The exemplary optimization algorithm can compute the new configurations after an initial period in which RESMs have discovered each other and have all initial SOCs and battery pack voltages needed for the startup of the algorithm. The optimization algorithm can compute a new configuration and set points periodically. A period is called a “time block”, which may be as fast as needed or desired to keep track of SOC and output voltage variations in the battery packs. Time blocks can be expected to be in the order of tens of seconds, but may be as fast as sub-seconds in more dynamic applications.

The exemplary optimization algorithm can use the predicted SOCs of all RESMs at the beginning of the next time block to compute several options for the converters power transfer ratios. From these multiple converter power transfer ratios, the optimization algorithm can find an optimum converter power transfer ratio that uses less power transferred and that satisfies the required terminal voltage while performing battery balancing. The embodiments can be configured to ensure power transfer ratios are selected in a way that balancing is achieved given the predicted SOCs of all batteries in the RESMs. For example, assume an energy system comprises three RESMs: RESM 1, RESM 2, and RESM 3, each with a predicted SOC equal to SOC[k,1], SOC[k, 2], and SOC[k, 3] for the beginning of time block k (this prediction is performed during time block k−1), where the second index within square brackets identifies the RESM the SOC belongs to, that is SOC[k, i] is the predicted SOC of the i^{th} RESM at time block k. Note that this prediction can be the last SOC in the previous time block (i.e., no prediction at all) and this can be acceptable because the SOC may not change substantially in the period between two time block periods. The SOCs can be ordered from largest to smallest as follows: SOC₁[k, 2]≥SOC₂[k, 3]≥SOC₃[k, 1] where the sub-index identifies the SOC position in this order, that is SOC₁ is the largest and SOC₃ is the smallest. In this example, RESM 2 has the largest SOC occupying 1^{st} position, followed by RESM 3 on 2^{nd} position and the lowest SOC is for RESM 1 on the 3^{rd} position. Note that in an embodiment this can be a descending ordered sequence based on SOC (as opposed to RESM identification number order) and this order can be set different to the RESM identification number on purpose to make that point clearer, but every permutation (i.e., 3!) is a valid ordered sequence of SOC, including SOC₁[k, 1]≥SOC₂[k, 2]≥SOC₃[k, 3]. In this exemplary approach, the SOCs of all RESMs can be ordered for every upcoming time block and tracked of what SOC belongs to what RESM.

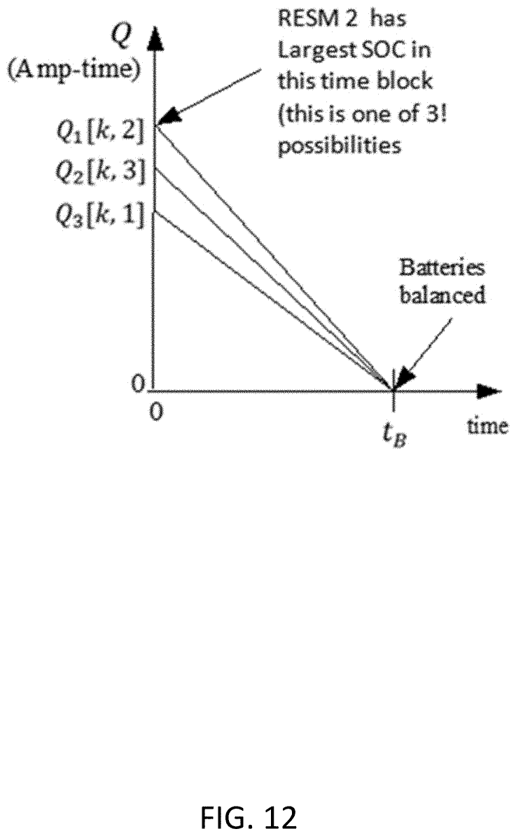

The nominal capacity of each battery in a RESM can be approximately the same and equal to Qₙ. One possibility to balance these batteries is shown graphically in FIG. 12. FIG. 12 is a time graph of an exemplary balanced discharged, where the y-axis is capacity in Amp-hours, and the x-axis is time, which starts from zero every time a new time block starts since past values may be unimportant for the algorithm computation. The capacity of each battery at time zero is the capacity at the beginning of time block k. t_{B} is the time at which balancing would be reached after the beginning of time block k assuming the conditions would not change. Assume Qₙ is given in Ah, and time is in seconds, if t_{B} is known the currents for each battery to achieve balancing at time t_{B} are equal to the slopes of the lines shown in FIG. 12, that is

I₁[k,2]=Q₁[k,2]/t_{B}=(SOC₁[k,2]·Qₙ·3,600)/t_{B}

I₂[k,3]=Q₂[k,3]/t_{B}=(SOC₂[k,3]·Qₙ·3,600)/t_{B}

I₃[k,1]=Q₃[k,1]/t_{B}=(SOC₃[k,1]·Qₙ·3,600)/t_{B}

The consistent notation is used, where Q₁[k, 2]>Q₂[k, 3]>Q₃[k,1] corresponds to our assumed order of SOC₁[k, 2]≥SOC₂[k, 3]≥SOC₃[k,1]. Note that the currents I₁[ ], I₂[ ], and I₃[ ] are the currents out of each battery in a RESM, the total output current I is the same in all RESMs as they are in series, but the individual currents out of each battery inside the RESM may be different due to a use of DC/DC converters and the by-passing mode (the battery mode, if used, would imply the battery current will be the same current as the load current I). In each RESM, the power transfer ratios of DC/DC converters needed to achieve these individual currents, and assuming a constant output current I, can be determined by using an equation of conservation of energy for a converter, that is

η·Vᵢ[k]·Iᵢ[k]=Vₒ[k]·I

In the equation, η is the efficiency of the converter, where has a value in the range: 0<η<1, and assumed constant, Vᵢ[k] and Iᵢ[k] are the input voltage and current of a converter respectively, Vₒ[k] and I are the output voltage and current of the same converter. The output current is equal to the load current and equal in all converters. This equation can be rearranged to find the DC/DC converter power transfer ratios as

M₁[k,2]=SOC₁[k,2]/t_{B},

M₂[k,3]=SOC₂[k,3]/t_{B},

M₃[k,1]=SOC₃[k,1]/t_{Bn}

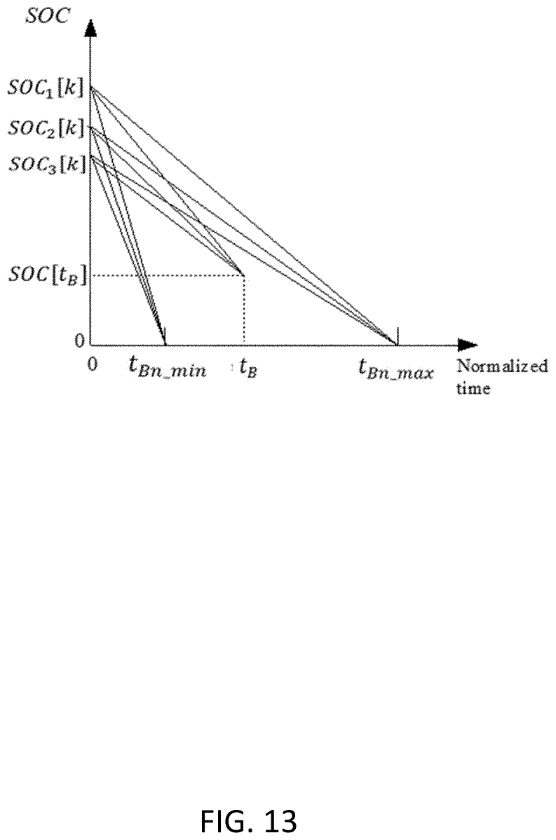

In the equation, t_{Bn}=t_{B}/Qₙ·3,600/(I/η)) is a normalized time. These relationships can imply that the transfer ratios can be proportional to the SOCs of each battery. This may not be the only possible case where batteries can achieve balancing. For example, there may be infinite possibilities, each will give a particular value of terminal voltage, but all possibilities must comply with the power limits of the DC/DC converters. For example, FIG. 13 is a graph of exemplary multiple balanced discharges with SOC versus normalized time. FIG. 13 shows several possibilities with a normalized time for the x-axis and the corresponding SOC for the y-axis. For clarity, the notation to identify the particular RESM (i.e., second index in SOCₓ[first index, second index]) can be dropped for a more compact description, but it is understood that an ordered SOC position sequence must match to a RESM identification number sequence that may be different. In the example, this means the SOC ordered sequence [1,2,3] corresponds to RESM id number sequence [2,3,1] for the time block k. The RESM label sequence may or may not change for a different time block depending on how SOC values change. Returning to FIG. 13, the illustration of embodiments can show at least two cases where balancing can be achieved at the time all batteries are empty (i.e., SOC=0), and there is one case where balancing is obtained at an SOC different than empty at t_{B} for which the converter transfer ratios are

M₁[k]=(SOC₁[k]−SOC[t_{B}])/t_{B}

M₂[k]=(SOC₂[k]−SOC[t_{B}])/t_{B}

M₃[k]=(SOC₃[k]−SOC[t_{B}])/t_{B}

and

M₁[k]=(SOC₁[k])/t_{Bn_max}

M₂[k]=(SOC₂[k])/t_{Bn_max}

M₃[k]=(SOC₃[k])/t_{Bn_max}

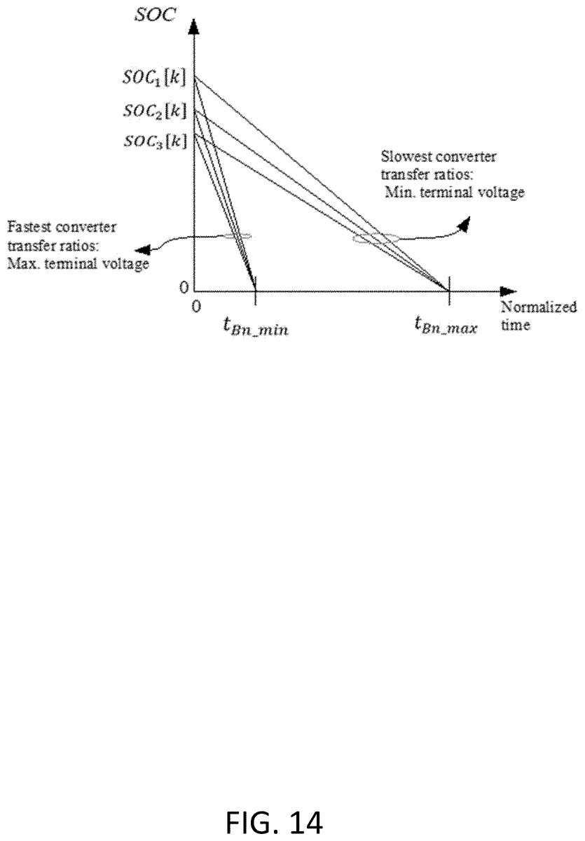

In some embodiments, this procedure can be expanded to include terminal voltage and the power limits of the converters by using the graphical help of the following figures. FIG. 14 is a graph of exemplary SOC dynamics at two different converter transfer ratios that achieve balancing showing a fast balancing embodiment that results in a maximum terminal voltage and a slow balancing embodiment that results in a minimum terminal voltage. FIG. 14. shows three RESMs with SOCs ordered from largest to smallest, SOC₁[k], SOC₂[k], and SOC₃[k] (again, dropping the notation that indicates which actual RESMs these are). These are discharged down to their empty state (i.e., SOC=0) using the largest converter ratios that ensure the total terminal voltage is at its maximum allowed level or the smallest converter ratios that ensure the minimum total terminal voltage. These two solutions achieve balancing at t_{Bn_min}, and t_{Bn_max} respectively, and at that point all batteries are completely or nearly completely discharged. As explained above, these are only two embodiments of the many possible solutions, and can be used as part of a search for the optimum solutions.

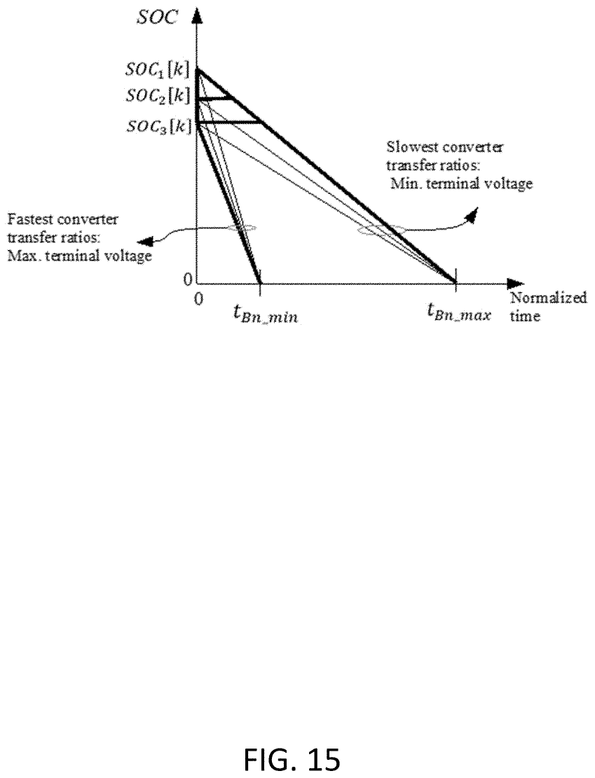

FIG. 15 is an example graph of exemplary SOC dynamics showing the boundaries for other candidate solutions, where other points within the region may be feasible solutions. Three regions are shown that overlap and are illustrated in the next figures separately. FIG. 15 shows overlapping bounds that can be used to find candidate solutions. Within the shown regions the optimization algorithm can search for points that satisfy all constraints, including required terminal voltage, balancing, and powers below maximum power of the converters in each RESM. The regions are N=3 bounded overlapping regions in this case as there are three RESMs in this exemplary embodiment.

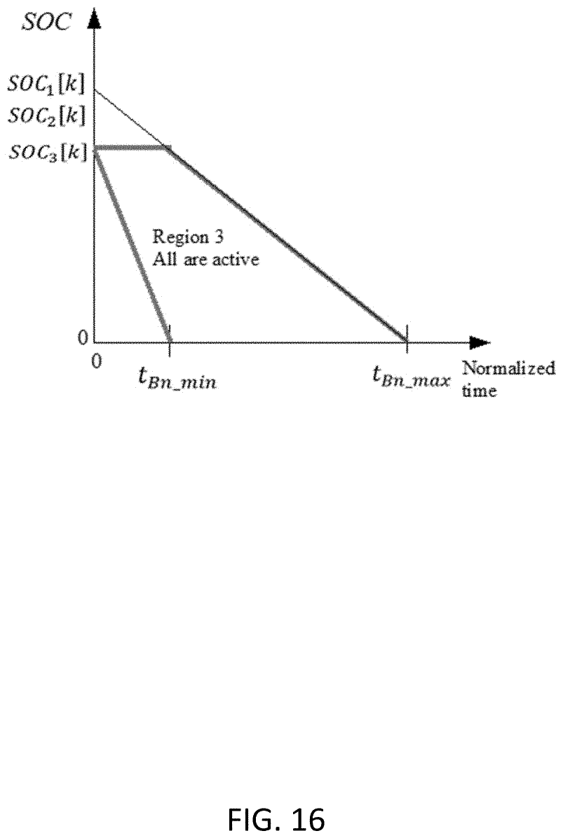

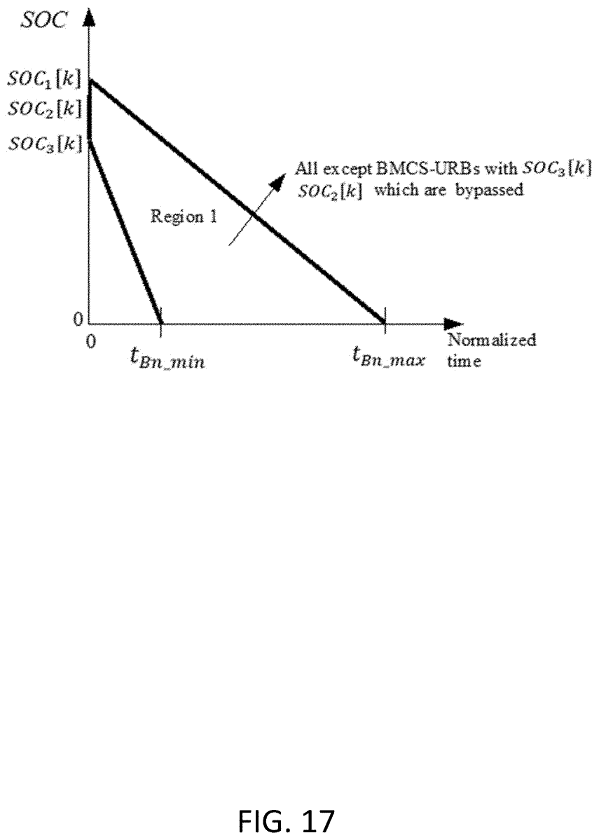

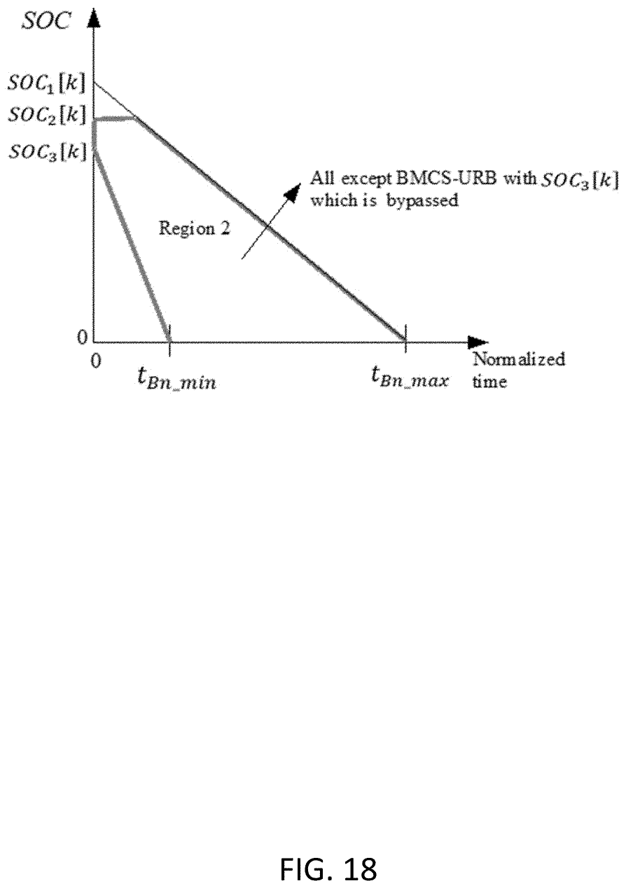

FIG. 16 is an example graph of Region N=3 of FIG. 15, where no RESM is bypassed (forced into limping mode) therefore all RESMs are allowed to discharge to a point within region 3 not including the top horizontal line. FIG. 17 is an example graph of Region 1 of FIG. 15, where all RESMs are bypassed except the one with largest SOC, that is, the RESM with largest SOC is allowed to discharge to a point within Region 1. FIG. 18 is an example graph of Region N−1=2 of FIG. 15, where in one embodiment RESM N is bypassed and the rest are active. That is, RESM N−1 is by-passed and all the other RESMs are allowed to discharge to a point in region 2. The top horizontal line is not included in the region. FIG. 16, FIG. 17, and FIG. 18 show the same bounds separately identifying the different limits by colors and numbers. Region 3 in FIG. 16 identifies an area where all RESMs can be discharged and where none are bypassed. The top horizontal line is not part of this region and therefore indicates that the lowest SOC RESM can only be discharged, but not charged or bypassed because its SOC must decrease but not stay the same or increase. In an embodiment, FIG. 17 shows Region 1 where only RESM with largest SOC is discharged and the rest are bypassed. In another embodiment, FIG. 18 shows Region 2 which is used when the RESMs with lowest SOC is bypassed (i.e., forced into by-passing mode) and the rest are discharged. The bypassing of RESMs can be useful in cases where the desired terminal voltage of the overall interconnection of RESMs is at or lower than the sum of all nominal voltage of the batteries. For example, if N=3, using a nominal 24V battery with a desired terminal voltage of less than or equal to 72V may require bypassing some RESMs, especially when the batteries are close to 100% SOC. Note that it is preferred to bypass RESMs and use boost mode in others to compensate for the drop in voltage as these are more efficient than bucking mode in some cases.

The regions in the graphs may be searched for feasible power transfer ratio points and used in a sequential manner starting with region N. That is, if N=3, and if the optimization algorithm of the embodiments can find feasible solutions within Region 3, the optimization algorithm can select the optimum of these, otherwise the algorithm tries in Region 2, if Region 2 still shows no feasible solutions, the algorithm moves on to Region 1. When no feasible solution exists in any of the regions, the optimization algorithm can relax the task of balancing the batteries and can attempt to find optimum solutions that maintains a regulated terminal voltage only (without balancing), if there is still no feasible solution after that an embodiment can configure the RESMs in an exemplary a-priori configuration. The exemplary optimization algorithm can balance the batteries if the difference in SOC is sufficiently large above a desired threshold, otherwise the optimization algorithm attempts to satisfy the required terminal voltage. Additionally, when forcing bypassing of RESMs as in Regions 1 and 2, the optimization algorithm can only switch the bypassing of batteries if the difference in SOC between the old and the new by-passed RESM is large enough.

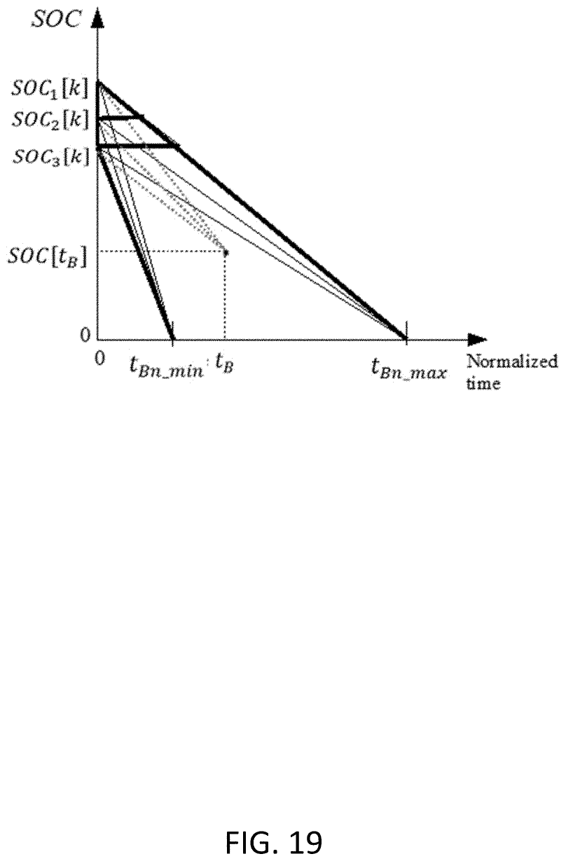

FIG. 19 is an example graph of an embodiment where exemplary SOC dynamics showing a different point within the allowed regions where a particular point achieves balancing before the batteries are empty. FIG. 19 shows a point where balancing is achieved at an SOC other than empty. All batteries achieved the same SOC at time t_{B} at which point their SOC is all equal to SOC[t_{B}]. After that point, all batteries are balanced. Inside these bounded regions the optimization algorithm can evaluate multiple points to select the one that satisfies all constraints. The optimization algorithm can then compute the converter transfer ratios for all feasible solutions, and use the transfers ratios to find the one that minimizes the total power transferred through DC/DC converters if any is used. The latter is an exemplary optimization objective of the embodiments. In other embodiments, the optimization algorithm outcome can be a specific output voltage for each DC/DC converter in the system that also satisfies minimum power transfer through DC/DC converters if any is used.

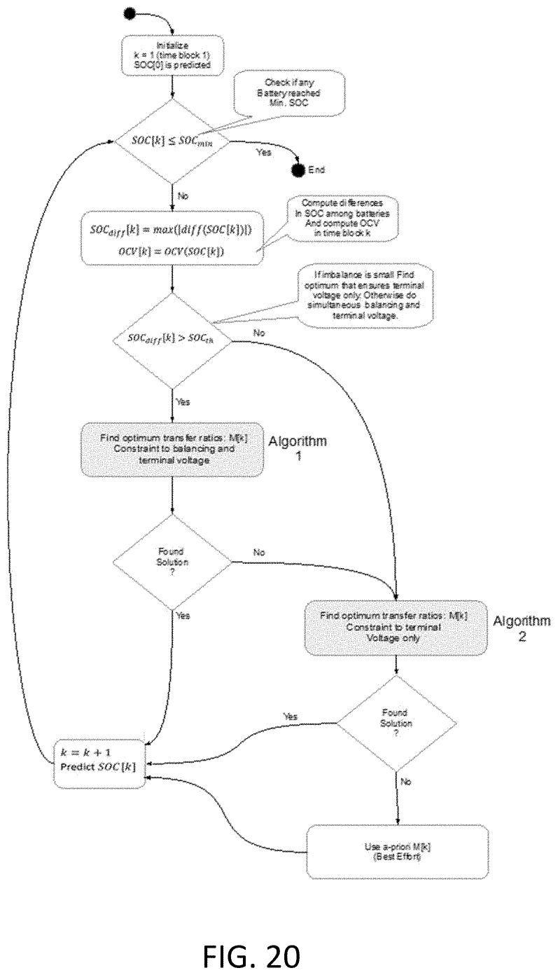

FIG. 20 is a flowchart of high level strategy of an exemplary RESMs algorithm for balancing and terminal voltage regulation of the embodiments. The embodiment of the optimization algorithm can compute transfer ratios M[k] inside the allowed regions where their relation ensures an SOC balancing point. The transfer ratios determined can be used to determine the mode of each RESM, its output voltage and the power through its DC/DC converter if needed, all before the beginning of the next time block. The process can be stopped when any battery reaches a minimum SOC threshold SOCₘᵢₙ. If the maximum difference in SOCs is above a threshold, such as but not limited to, typically more than 5%, the algorithm attempts to determine an optimum M[k] that can satisfy balancing and terminal voltage simultaneously. If the difference is small, such as typically less than 5% the optimization algorithm can determine an optimum M[k] that satisfies only terminal voltage as balancing is deemed unnecessary. If the optimization algorithm determines neither one of these is a viable solution, then the RESMs are configured into an a-priori or pre-determined configuration (e.g., battery mode). The optimization may then predict SOC for the next time block and repeat the process. Within the two embodiments for an optimization algorithm identified in FIG. 20 with grey color as Algorithm embodiments 1 and 2 there are several steps that are described next.

Optimization Algorithm Embodiment with Simultaneous Balancing and Terminal Voltage: Algorithm 1

This embodiment for an optimization algorithm analyzes all regions previously described and depicted in FIG. 16, FIG. 17, and FIG. 18 for a specific case of three RESMs in series. For example, starting from region N, the embodiment of Algorithm 1 can determine all points in that region, predict from these points the terminal voltage and converter power for all points, and then use these terminal voltages and powers to select feasible points. If feasible points are determined, the embodiment of Algorithm 1 can select an optimum point that minimizes some objective function. The selected transfer ratios M can then be used by the embodiment of Algorithm 1 to compute the output voltage of each RESM for the next time block such that every RESM is commanded to control its output voltage to a specific level. The control of the output voltage in each RESM is performed by its DC/DC converter controller which can maintain tight regulation of this voltage for an entire time block, and until it is commanded by the embodiment of Algorithm 1 to transition to a different mode or output voltage. This embodiment operates if the SOC difference is large enough, and depending on the application requirements, such as a typical 5%. If no feasible solution is found from all points in all regions, the embodiment of Algorithm 1 exits and lets the algorithm described in the next section operate (i.e., embodiment of Algorithm 2). If the SOC difference is small, such as but not limited to less than 5% which is typical, this algorithm is skipped and the algorithm in the next section can be executed instead.

Note that points within regions may or may not be feasible points, at this stage these points can balance the RESMs at a given time, but the Algorithm 1 must determine whether they are feasible for a solution. That is, do the RESMs require a power through a DC/DC converter that is within limits of the power that can be transferred through the DC/DC converters, and de they does the total voltage through the RESM modules add up to the desired terminal voltage within tolerance? The outcome of one of the points is a set of N converter transfer ratios, where N is the number of RESM modules, but these transfer ratios may not be feasible. Therefore, the Algorithm 1 inputs these found transfer ratios into a model of the RESM and predicts the output voltage of each RESM, and if a DC/DC converter is needed Algorithm 1 also computes the power through the DC/DC converter. If all these are within the required power and voltage limits of the DC/DC converters and the required terminal voltage of the load then this point is kept as a feasible point; this must be performed for all RESMs. After all feasible points are found the embodiment of Algorithm 1 can select (from the feasible points) the one that minimizes (or maximizes) a given optimization objective. Two exemplary optimization objectives may be the minimization of the maximum power through all converters used, or the minimization of the sum of all powers of all converters used. Other embodiments with optimization objectives can be implemented using the parameters and systems described herein. The prediction of the output voltage and power through converters can be performed in multiple ways. In one embodiment, the prediction can be determined as a circuit model of battery plus converter for every mode in every RESM or use of these models in combination with, for example, a Kalman filter that can adjust the prediction based on actual measurements as the modules are used. The accuracy of the prediction can improve efficiency and DC/DC converter utilization, but Algorithm 1 is robust enough such that efficiency can still be gained even under estimation errors and after safety margins are used.

In the embodiments, at each time block the modes and output voltages can be re-evaluated by Algorithm 1 to ensure RESMs are being discharged equally or that their SOC converge. This implies re-configuration can occur during operation. When the RESMs need to change modes, this can preferably be accomplished without the load noticing the change in modes. That is, current or voltage transients should be minimized to fall within acceptable limits. There are two features that make the minimization of voltage transients possible: 1) the transition between modes in a single RESM is transparent or smooth. That is, when transitioning between modes the terminal voltage of the RESM moves from the initial value to the final value of voltage in a monotonic manner, and 2) all RESMs should coordinate to perform the transition taking into account others or performing all the transitions at the same time. The latter may be possible if the load can tolerate a small transient due to time differences or the transient is fast enough that it can be absorbed by the input capacitance of the load. The coordination of all RESMs, on the other hand, may require intermediate modes to reach final modes. for instance, when RESMs must swap between battery and by-passing mode (i.e., one RESM transitioning from battery to by-passing and another from by-passing to battery mode). The exemplary algorithm can execute these types of transitions in an orderly and smooth fashion.

In an embodiment, a load current may change during a time-block. The Algorithm 1 can still maintain the desired terminal voltage as every RESM controls its output voltage using a tight closed loop control. In an embodiment, if all RESMs do the same, the overall terminal voltage will not change even when load changes. This implies, a change in original transfer ratio absolute value but the relative ratios will be approximately maintained as all adjust accordingly and in response to the current change which is passing through all RESMs in series. However, if the current exceeds the level of a specific DC/DC converter, the RESM can transition to battery mode or by-passing mode depending on the situation until the next time block where there will be another computation based on the new load current. This implies DC/DC converters may be designed considering worst case load conditions.

Optimization Algorithm with Terminal Voltage Constraint Only: Algorithm 2

An embodiment for the optimization algorithm can determine a feasible point that satisfies the terminal voltage constraint only. An exemplary “Algorithm 2” can be simpler and faster rather than optimum and can be executed in an exemplary processor and memory similar to Algorithm 1. Exemplary Algorithm 2 can be executed if Algorithm 1 is skipped by some of the reasons provided in the previously described embodiments. The Algorithm 2 can use measured battery voltages and then can find transfer ratios proportional to each battery voltage. For instance, if the desired terminal voltage is 120V and the battery voltages are 22V, 23V and 21V for three batteries, then the proportion of each battery from their sum can be calculated as 22/66=0.33, 23/66=0.35, 21/66=0.32 and the new voltages can be determined according to this proportion as 0.33×120=39.6V; 0.35×120=42V, and 0.32×120=38.4V. If the solution is feasible, that is the power through the DC/DC converters is less than the maximum power capability, these settings could be used. Otherwise an a-priori configuration could be used, such as all RESMs are set in battery mode. The latter is an exemplary embodiment. Other embodiments can make the load terminal voltage constant without regard of the energy storage module balancing.

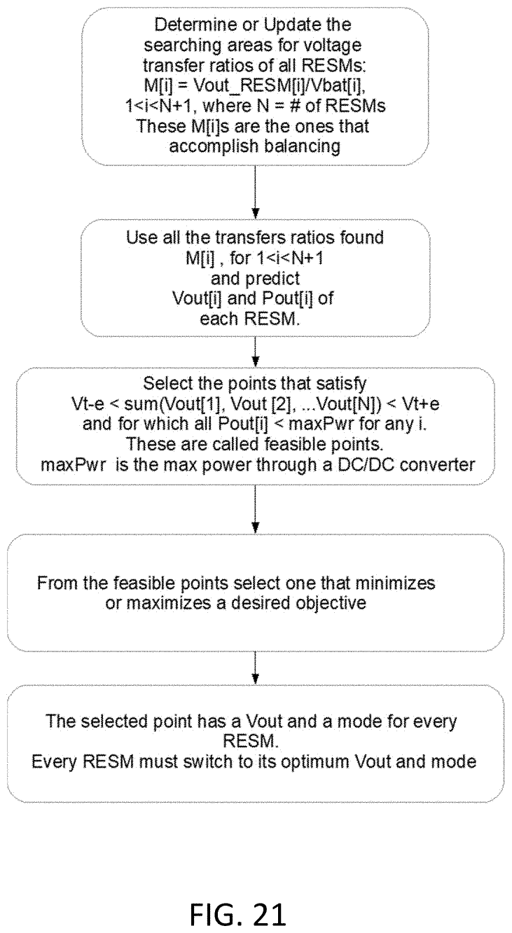

FIG. 21 shows a summary of the algorithm used to find feasible and optimum points. FIG. 21 is a flowchart of an exemplary optimization algorithm performed prior to a time block for the next time block of the embodiments. In FIG. 21, there is a value representing the tolerance allowed for the terminal load voltage. That is, it represents the fact that the sum of all voltages of al RESMs can be more than Vt-e and less than Vt+e in FIG. 21.

What is claimed is:

1. A modular energy management system, comprising:
a reconfigurable energy storage module (“RESM”), where the RESM comprises an energy storage module;
a processor executing an algorithm to operatively manage the RESM and execute instructions to perform the following step:
reconfiguring the RESM for one of load power, current, and voltage.

2. A modular energy management system, comprising:
at least two reconfigurable energy storage modules (“RESMs”) connected in series, parallel, or series/parallel, where each reconfigurable energy storage module comprises an energy storage unit;
a processor executing an algorithm to operative managing the RESMs and to perform the following steps:
reconfiguring the RESMs for one or more of load power, current, and voltage, regulation and control, and balancing of the energy storage units.

3. The modular energy management system of claim 2, wherein the algorithm to performs balancing of the energy storage units during charge and during discharge of at least one of the RESMs.

4. The modular energy management system of claim 2, wherein the processor executes the algorithm that performs balancing of the energy storage units simultaneous to one or more of load power, current, and voltage regulation and control.

5. The modular energy management system of claim 2, wherein the algorithm minimizes losses in the modular energy storage system using the RESMs.

6. The modular energy management system of claim 2, wherein the algorithm controls simultaneous service of multiple loads with different voltage, current, and/or power requirements in the modular energy storage system.

7. The modular energy management system of claim 2, wherein the algorithm reconfigures the RESM on-the-fly in multiple modes to obtain one of a terminal voltage, current, or power result.

8. The modular energy management system of claim 2, wherein the algorithm controls switches inside the energy storage unit for a dual and simultaneous functionality.

9. The modular energy management system of claim 2, wherein the algorithm controls bucking of load terminal voltage in the modular energy storage system by using boosted modules and by-passed modules in preference to bucking modules.

10. The modular energy management system of claim 9, wherein the algorithm controls a bucking mode to transition smoothly monotonically and with small-step transitions between battery and by-passing modes and vice versa to avoid sudden load terminal voltage changes as reconfiguration occurs on-the-fly.

11. The modular energy management system of claim 2, wherein the algorithm reconfigures the RESM on-the-fly and in a way that current is not interrupted and voltage transitions are monotonic in either increasing or decreasing direction with the purpose to operate the DC/DC converters at optimum operating points

12. The modular energy management system of claim 2, wherein multiple RESMs can interconnected to form a larger energy storage system and where these RESMs make use of the boosted mode having the DC/DC converter in parallel with the battery in its input and in series with the battery in its output

13. The modular energy management system of claim 2, wherein the algorithm is used to reconfigure one or more of the RESMs on-the-fly to regulate and control either one or more of the load power, current, and voltage and with the RESMs interconnected in series, parallel, or series/parallel

14. The modular energy management system of claim 2, wherein the algorithm is used to minimize the power transferred through the associated DC/DC converters and maximize the power delivered by the batteries directly when performing regulation and control of either one or more of the load power, current, voltage, and balancing of the energy storage system formed by the series, parallel, and series/parallel interconnection of one or more of the RESMs.

15. The modular energy management system of claim 14, wherein the algorithm and RESMs are used for charging the batteries in every RESM interconnected in series, parallel or series/parallel

16. The modular energy management system of claim 2, wherein the algorithm is used to jointly or separately regulate and control load power, voltage and current and simultaneously or separately balance the energy in the batteries of the energy storage system formed by the interconnection of multiple RESMs in series, parallel or series/parallel

17. The modular energy system wherein modules forming a larger energy storage system make use of on-the-fly reconfiguration to jointly or separately accomplish either one or more of the load power, current and voltage regulation and the balancing of the energy storage system formed by the series, parallel, or series/parallel interconnection of energy storage modules such as the RESM and with the purpose of minimizing the amount of power being transferred through the distributed DC/DC converters or operate them closer to nominal conditions for purposes of maximizing efficiency
